(19) United States
(12) Patent Application Publication
(10) Pub. No.: US 2021/0319184 A1
(43) Pub. Date: Oct. 14, 2021

(54) RECOGNITION OF SENSITIVE TERMS IN TEXTUAL CONTENT USING A RELATIONSHIP GRAPH OF THE ENTIRE CODE AND ARTIFICIAL INTELLIGENCE ON A SUBSET OF THE CODE

(71) Applicant: JEFFERSON SCIENCE ASSOCIATES, LLC, Newport News, VA (US)

(72) Inventors: Christopher Williamson, Hampton, VA (US); David Lawrence, Newport News, VA (US); Kishansingh Rajput, Newport News, VA (US)

(21) Appl. No.: 17/196,312

(22) Filed: Mar. 9, 2021

Related U.S. Application Data
(60) Provisional application No. 63/008,696, filed on Apr. 11, 2020.

(51) Int. Cl. G06F 40/295; G06N 20/00; G06F 40/253

(52) U.S. Cl. CPC G06F 40/295; G06N 3/04; G06F 40/253; G06N 20/00

(57) ABSTRACT

A method for analyzing existing digital files to recognize sensitive data in the textual content. The method includes extracting features describing the environmental context in which a file was created and the file content itself and modeling and analyzing pairwise relations between text that exist within a given file; the text itself; and characteristics that exist about the text in relation to the entire file. The method takes the extracted features, including the data itself and its context, and analyzes this data with artificial intelligence (AI) algorithms such as decision trees and neural networks to predict whether a document includes sensitive data. Leveraging AI algorithms rather than discrete algorithms carries with it the advantage of being able to handle massive volumes of data, as well as the ever increasing varieties of data.

This application claims the benefit of Provisional U.S. Patent Application Ser. No. 63/008,696 filed Apr. 11, 2020, the contents of which are incorporated herein by reference in their entirety.

The United States Government may have certain rights to this invention under Management and Operating Contract No. DE-AC05-06OR23177 from the Department of Energy.

### FIELD OF THE INVENTION

The present invention relates to the prevention of unauthorized access to sensitive data, and more particularly to a method for analyzing digital files to recognize any sensitive data in the textual content.

### BACKGROUND OF THE INVENTION

The prevention of sensitive data leakage is of utmost priority to today's consumers and organizations. This is a preeminent concern in the evolving field of cybersecurity. It is a top priority for cyber practitioners to aid individuals and organizations in the prevention of unauthorized access to sensitive data.

Current digital files analysis methods do not appear to use artificial intelligence (AI) and do not appear to consider environmental context in which the document was discovered. Current technologies include those likely employing discreet algorithms but not making use of true artificial intelligence. A further limitation of these technologies is that they analyze documents without considering the environmental context in which they were created. Additionally, none of them seem to suggest utilizing graph theory as a pre-processing means for extracting features or reducing the data set in preparation for analysis.

These prior art methods rely heavily on performing analysis about how the data is being accessed rather than contextual features learned from the data itself. These prior art methods are extremely limited in that one would need to have control and/or develop insight into the underlying system on which the data resides, and perform extensive training on each system. They must run on the provider's specific platform in order to make an accurate prediction. The prior art methods all appear to not use AI and further appear to be platform specific and therefore not usable on all textual data. So these prior art methods are not something someone can run on their computer, cell phone, or web site. Accordingly, there is a need for better techniques for analyzing digital files to recognize any sensitive data in the textual content.

### OBJECT OF THE INVENTION

It is an object of the invention to provide an improved method for analyzing existing digital files and those to come in the future. The method in essence extracts features describing the environmental context in which a file was created and the file content itself by modeling and analyzing:
a. pairwise relations between text that exist within a given file (Graph Theory);
b. the text itself; and
c. characteristics that exist about the text in relation to the entire file.

These and other objects and advantages of the present invention will be understood by reading the following description along with reference to the drawings.

### SUMMARY OF THE INVENTION

By extracting features beyond that of just the text itself, the method captures extended metadata about a given document that previously would not have been realized. The method extracts features representing elements such as: grammatical habits of authors, common document structures, and various linguistic characteristics. The method takes these extracted features (representing the data itself and its context) and analyzes this data with artificial intelligence (AI) algorithms such as decision trees and neural networks in an effort to predict whether a document includes sensitive data. Leveraging AI algorithms rather than discrete algorithms carries with it the advantage of being able to handle massive volumes of data, as well as the ever-increasing varieties of data. The method proposed here can be easily included in software written by cybersecurity firms, and used by organizations or individuals to run on their systems to discover the existence of sensitive data in places previously unknown to them. The method of the current invention is built with “Big Data” in mind, so that it will scale to meet the privacy needs of consumers and organizations.

The current invention, which introduces a novel method for finding the existence of such sensitive data in textual content, is unique in the following ways:
a. Rather than merely analyzing the data in a text document itself, we are attempting to analyze the data along with this environmental context to predict whether the document contains sensitive information.
b. The method employs graph theory techniques as a heuristic means of extracting a dataset which represents the environmental context in which a document was developed and how the document was developed (e.g. the tendencies/habits of an author, the type of document that is being written, the grammatical constructs employed). This is a novel way to use graph theory.
c. Rather than a human analyzing the data and its context in an effort to develop some discreet algorithm for performing this analysis, the method uses machine learning algorithms (Artificial Intelligence).

Sensitive information such as passwords, credit card numbers, social security numbers, etc., is often embedded in digital text documents (computer files, web pages, spreadsheets, etc.). The problem comes when these documents are made broadly accessible to individuals that are not authorized to access this sensitive information usually through unintended means. This problem is exacerbated with the growth of cloud service providers and the increasing comfort with posting documents in the cloud. There are existing tools that leverage discreet algorithms for finding such documents with sensitive data in them, but these algorithms are difficult to maintain and rely on human intelligence to hard code the methodology by which the documents are analyzed, thereby drastically limiting the software's ability to find certain indicators of documents with sensitive information. The current invention solves that problem. It will rely on artificial intelligence algorithms that will learn previously unobserved semantics of documents containing sensitive information, then make accurate predictions about new unseen documents as to whether or not they contain sensitive data. This invention, while valuable for all textual content, is particularly well suited for structured textual content, such as text structured in markup languages, programming languages, etc.

The method of the current invention would be beneficial to software developers who embed keys and passwords in code, businesses with sensitive data, home users with computers or cell phones, and any individual that utilizes cloud services.

### BRIEF DESCRIPTION OF THE SEVERAL VIEWS OF THE DRAWING(S)

Reference is made herein to the accompanying drawings, which are not necessarily drawn to scale, and wherein:

FIG. 1 illustrates an easy example of C language code for extracting information from files with textual content.

FIG. 2 illustrates another example of C language code for extracting information from files having textual content, this one being of moderate difficulty.

FIG. 3 illustrates yet another example of C language code for extracting information, this one being more difficult than the examples shown in FIGS. 1 and 2.

FIG. 4 illustrates, for the example of FIG. 3, the use of a graph as a pre-processing means for extracting features or reducing the data set in preparation for analysis.

FIG. 5 illustrates the use of Python language code for extracting information.

FIG. 6 illustrates an example of environmental context made from file metadata that is mapped into a graph. AI can use this as additional inputs to then decide if a file is likely to contain sensitive information.

FIG. 7 illustrates the graph made from the environmental context metadata as described in FIG. 6.

FIG. 8 illustrates an example of python code for logging into the server to perform monitoring.

FIG. 9 illustrates, for the program of FIG. 8, a first step for extracting features or reducing the data set in preparation for analysis.

FIG. 10 illustrates outputting graphical results of the extracted features from FIG. 7.

FIG. 11 illustrates a third step in the method for analyzing digital files to recognize sensitive data in the textual content, including training a deep learning model on the graphical data (as in FIG. 10) and inference on new files to classify them as to whether they contain sensitive information or they do not.

FIG. 12 illustrates the Flow chart of the whole system.

### DETAILED DESCRIPTION

The system of the present invention is capable of classifying a programming (segment of) code as to whether it contains some sensitive information. When any code is written, the programmers have a certain mindset; if they tend to incorporate sensitive information in the code, they may have certain writing traits or some coding style habits. Any experienced or well-groomed programmer will avoid putting sensitive information in the code, hence it is more likely that a relatively new programmer will tend to put sensitive information inside the code. The system will look at the actual text in the code along with the relationship of individual words with other words as well as with the whole text.

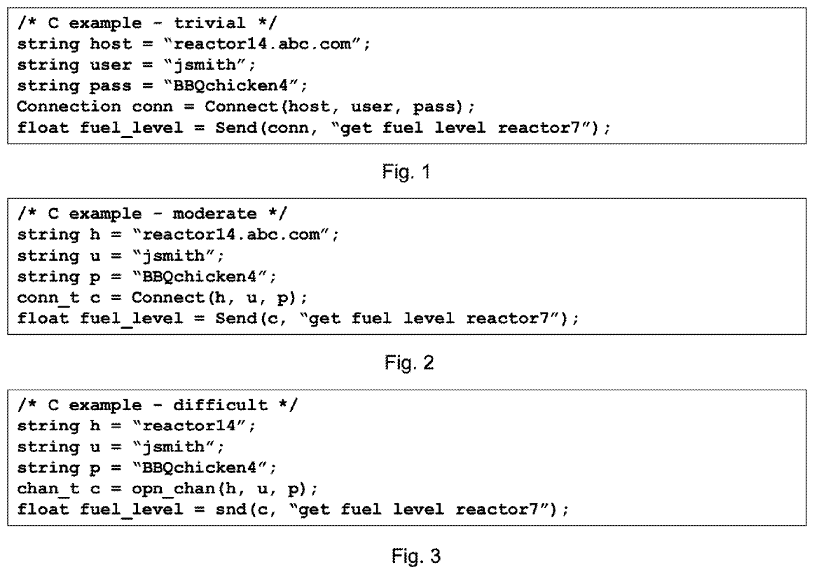

FIGS. 1-3 show three code examples that are functionally identical, but whose choices of variable and function names make them increasingly more difficult when using traditional string matching techniques. An experienced programmer could identify the intent of the code in the last example. An AI based system as described here would mimic this ability and be able to identify this as a pattern containing login information even if buried deep in a large code base.

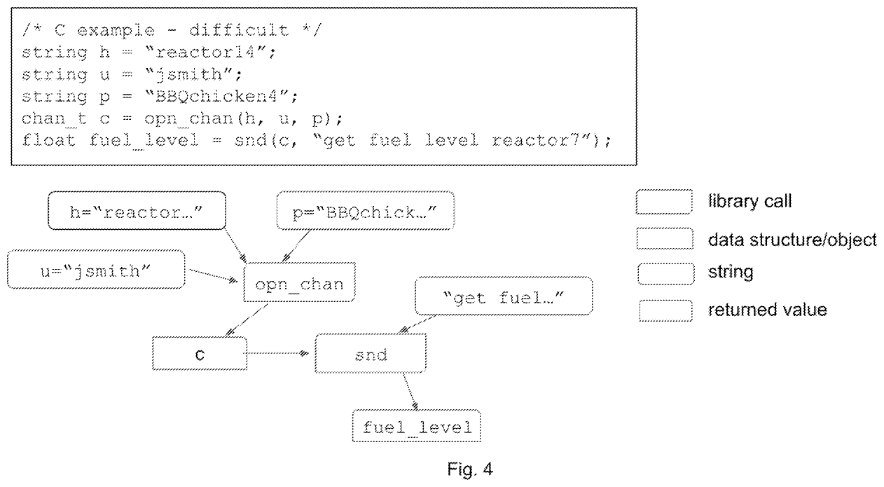

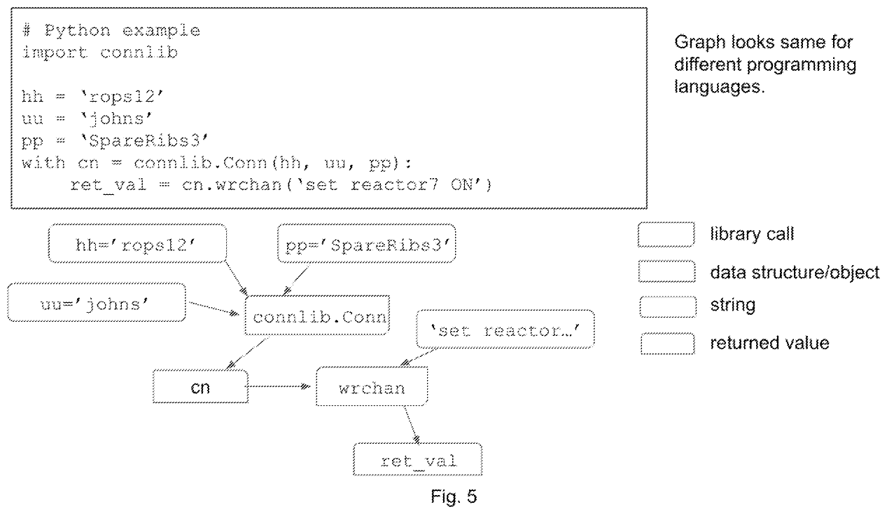

FIGS. 4 and 5 show an example of code written in two different languages (C for FIG. 4 and Python for FIG. 5). The figures also show graphs representing the relationship between code elements. This illustrates how the graph can be similar, even for different programming languages. The system being described here would consist of an AI model capable of identifying these types of subgraphs within larger program graphs in a way that would make it language independent.

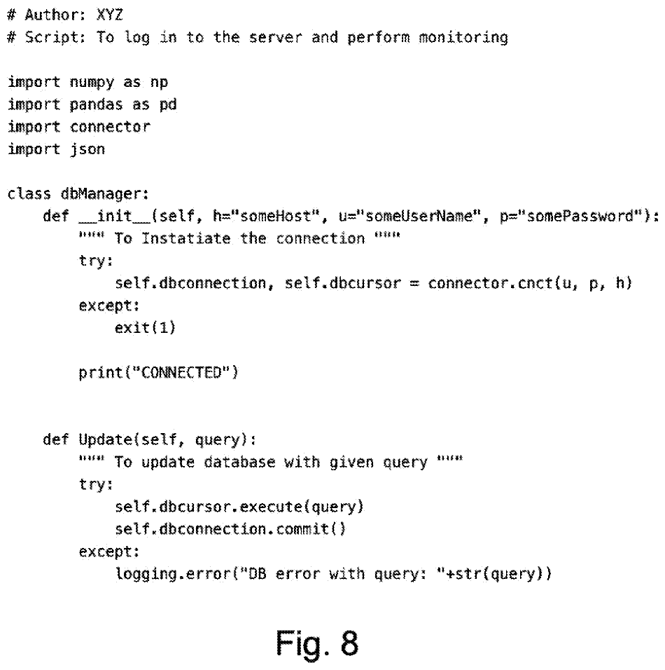

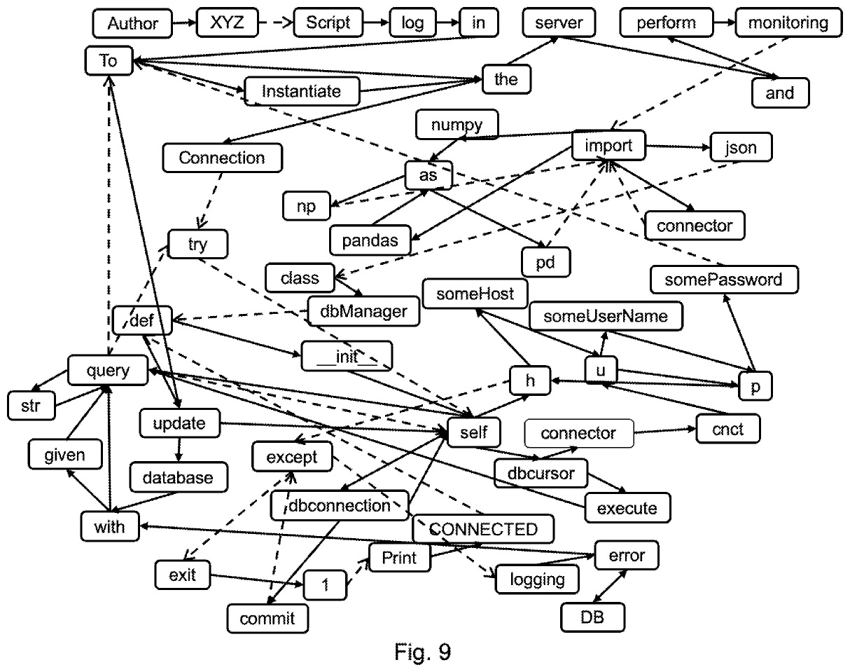

FIG. 8 shows a segment of code in python programming language that is converted to graph as shown in FIG. 9. Each unique word in the code text is treated as a node of the graph. The relation between these words are described in the form of connections between these nodes. There may be different relationships between two words in the text but the most common and perceptive relation is the relative position. If two words occur together, their respective nodes are connected in the graph. If two words occur together in the same sentence they are connected with a solid edge; on the other hand if they occur together as last and first word of two consecutive lines, they are connected with a dashed edge as shown. The frequency of the occurrence of a pair of two words together can be considered as the weight of the edge between them. The graph can be customized to have more than one edge representing different features between the same two nodes. Other features that may be considered are the length of the first word in a pair, the length of the second word in a pair, and the position of the word-pair in the sentence etc.

Instead of feeding the graph directly to an AI system, the invention proposes use of adjacency representation of the graph since we may have more than one edge between two nodes representing different features. These customized graphs can be easily represented with 3-dimensional adjacency matrices.

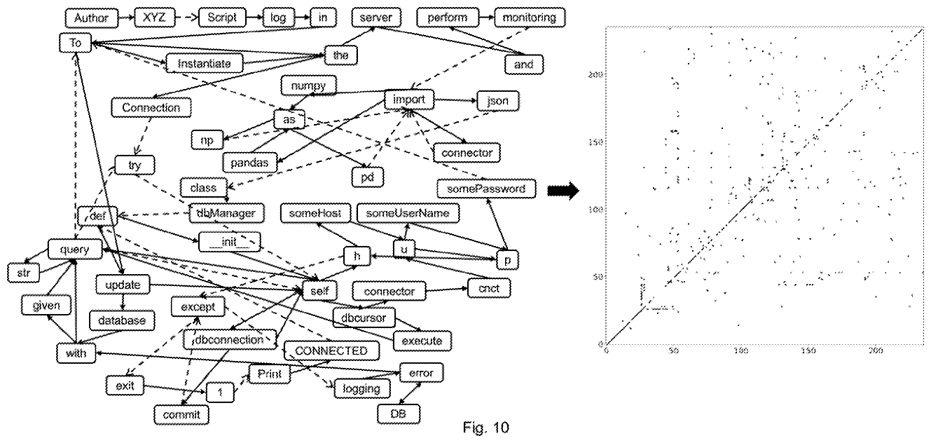

FIG. 10 shows how a customized graph is converted to an adjacency matrix. In this 3-dimensional matrix the first two dimensions are an index of the words in the text while the third dimension has one entry for each feature considered. Each edge weight is an entry to the respective cell of the matrix. Considering 3 features (more than 3 features can also be considered) including the frequency of two words occurring together, the length of the first word in the pair, and the length of the second word in the pair; the adjacency matrix has 3 channels on the third dimension.

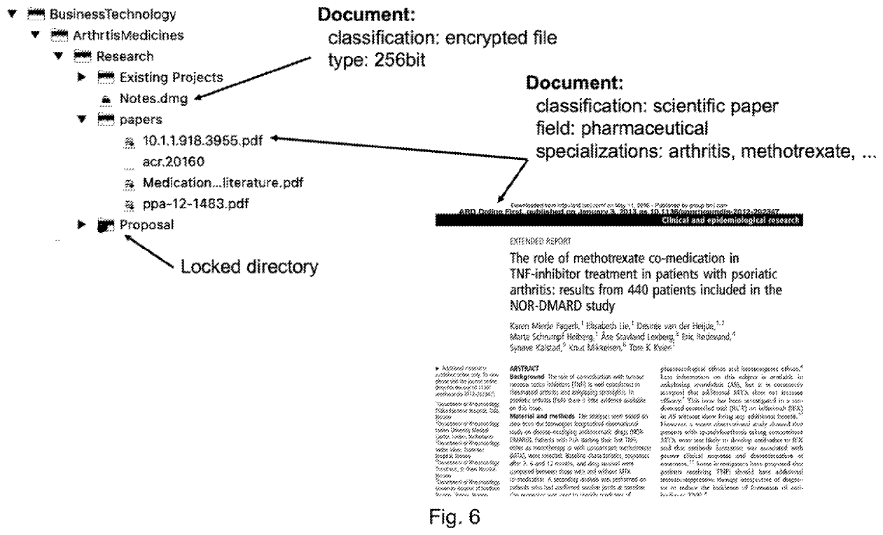

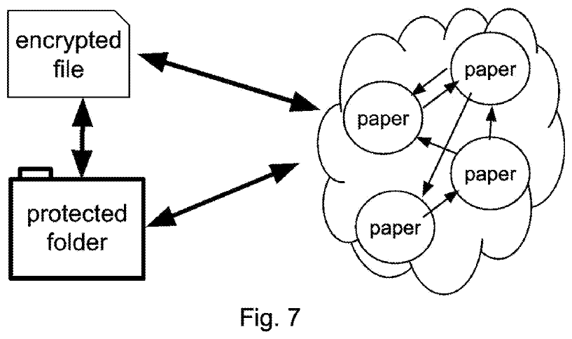

FIGS. 6 and 7 demonstrates how the environmental context in which a file is discovered may be used to identify files with sensitive information and the nature of that information. In this example, an encrypted document called “Notes.dmg” is found in the vicinity of several scientific papers all on a related subject. Also present is a locked directory. Even without direct access to the contents of the locked directory or the encrypted file, one may infer that sensitive data exists and that it is related to the topic which the scientific papers present. FIG. 7 illustrates a simple graph representing the key elements of files in the directory tree. This would include metadata about the files (e.g. is encrypted, is directory, is protected, is scientific paper, etc. . . . ). For the current system, the AI would include this metadata graph to help determine the likelihood of sensitive information being in a file or directory. This could be used with the direct contents of the file(s) or without it if the content is not accessible.

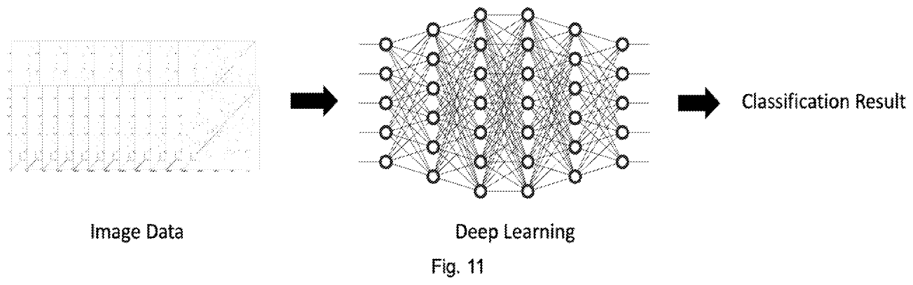

FIG. 11 illustrates the final stage of the system where the data generated in FIG. 10 and FIG. 7 are fed into a deep learning model. This model is trained on a large number of such data samples that are labeled. Once trained the model has learned the patterns and traits found in the documents that contain sensitive information. Now, upon feeding new samples the model can quickly classify as to whether they have sensitive information based on previous patterns learnt. The AI model may need to be retrained periodically.

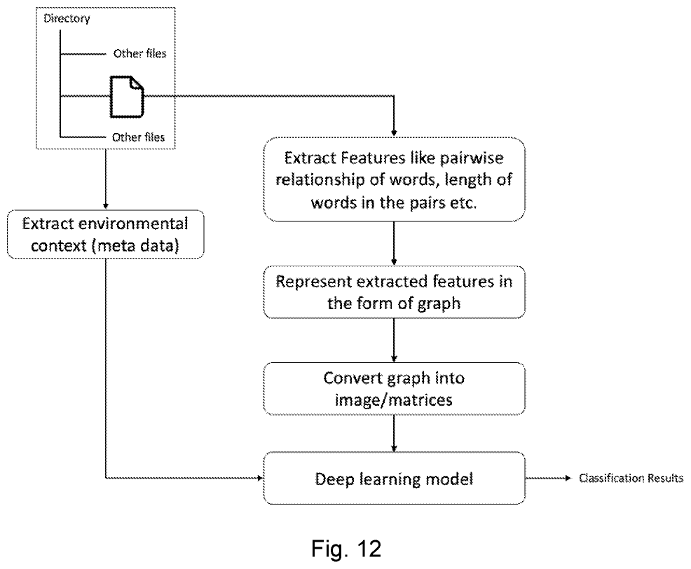

FIG. 12 represents the overall flow of the proposed system. Two set of features, such as environmental context and local features of the actual text are extracted simultaneously. Processing is done on them to make them feedable to a deep learning model, after which this set of features are then fed into the model to get the result.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for analyzing a digital file to recognize sensitive data in the textual content, the method comprising:
extracting a first set of features from the data within the digital file;
extracting a second set of features from the environmental context in which the file was created and from the file context itself;
representing the extracted features in the form of a graph;
converting the graph into an image or matrix;
feeding the sets of extracted features to a deep learning model;
continuing to feed data until the deep learning model has learned the pattern and traits found in the digital files;
feeding additional samples to determine whether the file contains sensitive information based on previous patterns and traits learned; and
outputting the classification results.

2. The method of claim 1, wherein the extracted features are analyzed using machine learning algorithms or artificial intelligence (AI).

3. The method of claim 2, wherein the AI algorithms are selected from the group consisting of:
decision trees and neural networks.

4. The method of claim 1, wherein the extracted features comprise:
the context of the data;
grammatical habits of authors;
common document structures; and
various linguistic characteristics.
